(19) United States
(12) Patent Application Publication
(10) Pub. No.: US 2011/0028256 A1
(43) Pub. Date: Feb. 3, 2011

(54) CHAIN

(75) Inventors: Michael Godfrey, Lakewood, CO (US); Torquil Edmund Meredith Pyper, Oxford (GB); Michael Charles Christmas, Cheshire (GB); Christopher James Lodge, Derbyshire (GB)

Correspondence Address: MICHAEL BEST & FRIEDRICH LLP, 100 E WISCONSIN AVENUE, Suite 3300, MILWAUKEE, WI, 53202, US

(73) Assignee: RENOLD PLC, Manchester (GB)

(21) Appl. No.: 12/935,340

(22) PCT Filed: Apr. 8, 2009
(86) PCT No.: PCT/GB09/00919

§ 371 Date: Sep. 29, 2010

Related U.S. Application Data
(60) Provisional application No. 61/045,328, filed on Apr. 16, 2008.

(51) Int. Cl. F16G 13/06

(52) U.S. Cl. 474/228

(57) ABSTRACT

A chain such as a roller bush chain comprising a plurality of interconnected chain link members (2,3) is provided with a wiper element (9) that extends at the interface between overlapping portions of the link members. The wiper may be a formation defined on one of the link members or a bush (8) of the chain or may be a separate component between the link members. The wiper has a wiping edge that in use moves relative to a surface of at least one of the members and serves to wipe that surface clean of deposits or debris so as to allow lubricant to penetrate to the bearing between the pin and link members or bush and to reduce the risk of wear.

The present invention relates to a chain, such as a transmission chain, and more particularly, but not exclusively, to a pin oven chain.

Pin oven chains are used to convey metallic objects such as, for example, beverage cans, through an oven where they are heat-treated. In particular, the exterior surface of cans of this kind are printed and/or otherwise coated and the coating is then cured by the heat treatment process. The pin oven chain is often a conventional roller bush chain that has been modified such that certain pins of the chain are extended significantly on one side to form carrier pins that support the object. In the case of a beverage can, an open end of the can fits over the extended pin such that it is supported and can be conveyed through the oven.

Effective lubrication of a pin oven chain can be problematic. There are generally strict controls on the amount of lubricant that can be used so as to reduce the risk of contamination of the beverage cans. Moreover, in the environment of a high temperature oven lubricating oil suffers from coking and the resulting carbon deposits are often burnt on to the chain components. The presence and accumulation of such deposits restricts the passage of lubricant to the pin and bush interface thus causing chain wear and so pin oven chains have to be replaced regularly.

It is an object of the present invention to obviate or mitigate at least one of the aforesaid disadvantages and/or to provide for an alternative or improved chain.

According to the present invention there is provided a chain having a longitudinal axis and comprising a plurality of interconnected chain link members, the link members being arranged along the longitudinal axis of the chain into inner link members that are flanked on each side by outer link members, the outer link members extending between adjacent inner link members, a pair of apertures defined in each of the link members and spaced apart in the direction of the axis, the inner link member having an outwardly facing surface with respect to the axis and the outer link member having an inwardly facing surface, the inner and outer link members being arranged such that one of the pair apertures in each of the outer and inner link members are in alignment and such that the outwardly facing surface of the inner link member and the inwardly facing surface of the outer link member partially overlap at an interface region in an area around the aligned apertures, the inner and outer link members being interconnected by the transverse pins that are received in the aligned apertures, a wiper element provided at the interface region and defining a wiping edge that contacts, and is movable relative to, at least one of the surfaces in the interface region.

The wiper element serves to wipe clean at least one of the outwardly facing surface of the inner link member or the inwardly facing surface of the outer link member in the interface region so that it is clear of deposits, debris or sludge that may otherwise serve to prevent effective lubrication of the chain or to increase the tendency of the chain to wear. The chain is thus self-cleaning.

The inner link member may comprise at least one inner link plate. It may also comprise a pair of opposed inner link plates. The chain may further comprise bushes that are received in the apertures of the inner link plates and serve to join together the opposed inner link plates, the bushes being arranged so as to receive the transverse pins, the bushes being rotatable on said transverse pins so as to allow the inner link members to articulate relative to the outer link members, the outer link members being fixed so said pins. A roller may be rotatably disposed on each bush.

The outer link members may each be in the form of a plate.

The wiper element may be a part of the inner or outer link member, either integrally formed therewith or fixed thereto. For example the wiper element may be defined by a protrusion, such as a rib or the like, on one of the surfaces in the interface region or it may be defined by a groove defined in one of the surfaces, an edge of the groove providing the wiping face. The protrusion or groove may extend in the interface region from one of the apertures in the inner or outer link member to a peripheral edge thereof and may extend in a generally radial direction with respect to the aperture. In one embodiment the protrusion may be defined on the outwardly facing surface of the inner link member and the chain may further comprise bushes as referred to above, in which instance the protrusion may be disposed over an end of the bush that extends outwardly of the inner link member and the bush is provided with a notch adjacent to the protrusion to allow for passage of lubricant to the pin.

In embodiments where the chain has a bush, the wiper may be defined by a protrusion such as, for example, a finger extending outwardly from an end of the bush and along the interface region. The finger may be integrally formed with or fixed to the bush.

Alternatively, the wiper element may be defined by a protrusion, such as for example a finger, extending from an edge of a first inner link member into an interface region between an adjacent inner link member and an outer link member. In such an embodiment the protrusion may extend generally in a direction substantially parallel to the axis of the chain and may be stepped to define a first portion that extends outwardly of the axis and a second portion that extends in a direction substantially parallel to the axis of the chain, such that it extends around and over the adjacent inner link member.

Alternatively, the wiper element may be defined by a separate wiper member disposed between the inner and outer link members. The wiper member may be mounted on at least one of the pins and may be fixed or movable (e.g. rotatable) relative to the pin. In one embodiment the wiper member may be an elongate member supported in a bore in one of the pins such that it extends in a direction transverse to the pin and substantially parallel to the interface region. The elongate member may be in the form of a cylindrical rod that may extend radially outwards from the pin. It may extend outwards at diametrically opposite locations.

In an alternative embodiment the wiper member comprises a first portion supported around a pin and a second portion extending outwardly from the first portion and defining the wiping edge. The first portion may be in the form of an annular or partially annular member and the second portion may be in the form of an arm or blade that may extend in a substantially radial direction with respect to the pin. There may be more than one arm (which may be in the form of a blade) and in such an embodiment the arm may extend inwardly of the annular or partially annular member. Such inwardly extending arms may be received in openings, such as apertures or slots, defined in a bush of the chain. The annular or partially annular member may have slots to allow for the passage of lubricant to the pin.

The annular or partially annular member may have a link arm for connection to a corresponding link arm of an adjacent wiper member. The two link arms may overlap and may have slots, which may be closed. A connecting link pin may reside in the closed slots so that the two wiper members move in unison. Alternatively a link arm of a first wiper member may be received in an open slot of a link arm in a second wiper member which is adjacent to the first wiper member.

Alternatively the first portion, which is mounted on a pin of a first inner link member, may have a link arm with an open slot that receives a link pin defined on an adjacent second inner link member so that articulation of the second inner link member relative to the first inner link member causes the link pin to move the link arm and thereby effect rotation of the wiper member.

The wiper member may be in the form of a resilient clip with at least one arm (which may take the form of a blade) extending outwardly from the first portion of the wiper member. The clip may be a unitary member defining a pair of ends, one or both of which define the wiping edge. The clip may comprise an intermediate portion extending between the two ends, the ends being arranged around the pin or pins of the chain. The intermediate portion may extend between two or more pins of the chain. The intermediate member may be arranged so as to be engageable by a protrusion defined on an inner link member during articulation of the chain, the engagement effecting flexing or movement of the wiping edge defined on the end or ends of the wiper member. Alternatively the protrusion may be a pin or bush of the chain. The intermediate portion may extend outboard of the peripheral edge of the inner link member and may be engageable by a cam surface arranged alongside the path of the chain.

The ends of the clip may define wiping edges that extend in same direction or opposite directions. The intermediate portion may be substantially parallel to the axis of chain.

In a further alternative embodiment the wiper member is in the form of a plate having at least one edge that defines the wiping edge. The plate may be disposed between the inner and outer link members and may have first and second ends each with a recess for engaging the plate pins of the chain. The plate may have opposed surfaces which may have grooves or similar formations that may serve as wiping edges.

In a yet further embodiment the wiper member may define a surface that faces the inner link member, the surface having at least one groove whose edge defines the wiping edge. The at least one groove may extend in any suitable direction. There may be provided a plurality of substantially parallel grooves. The wiper member may be in the form of a washer mounted on a pin of the chain. There may be a pair of adjacent wiper members mounted on adjacent pins of the chain, the periphery of each wiper member having teeth for driving engagement with the teeth of the other wiper member. The wiper member may be corrugated to define the at least one groove. In use, the periphery of the wiper member may be designed to engage with a cam surface defined alongside the path of the chain.

Specific embodiments of the present invention will now be described, by way of example only, with reference to the accompanying drawings in which:

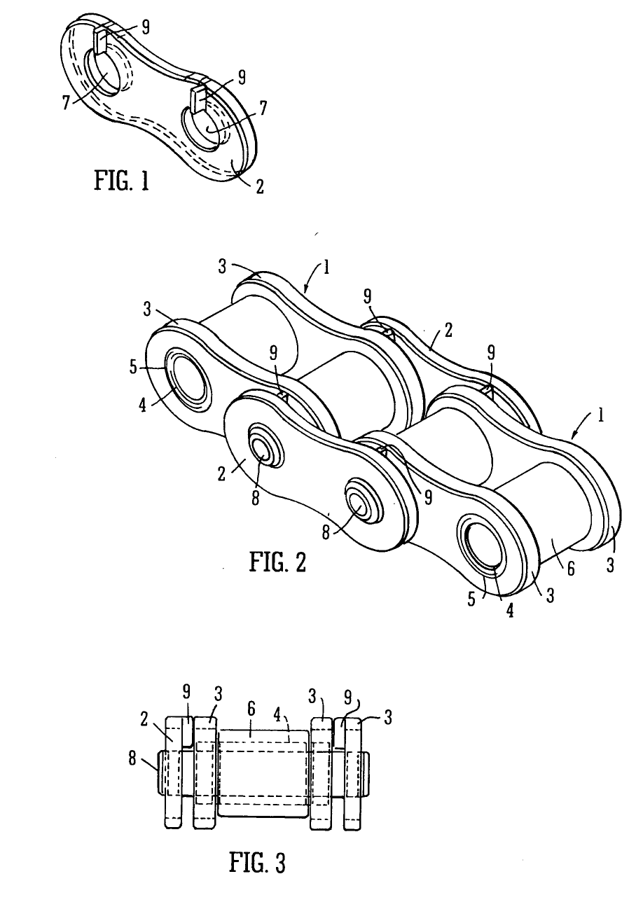

FIG. 1 is a perspective view of an outer link of a roller bush chain in accordance with a first embodiment of the present invention;

FIG. 2 is a perspective view of part of the first embodiment of a roller bush chain of the present invention fitted with outer links of FIG. 1;

FIG. 3 is an end view of the roller bush chain of FIG. 1;

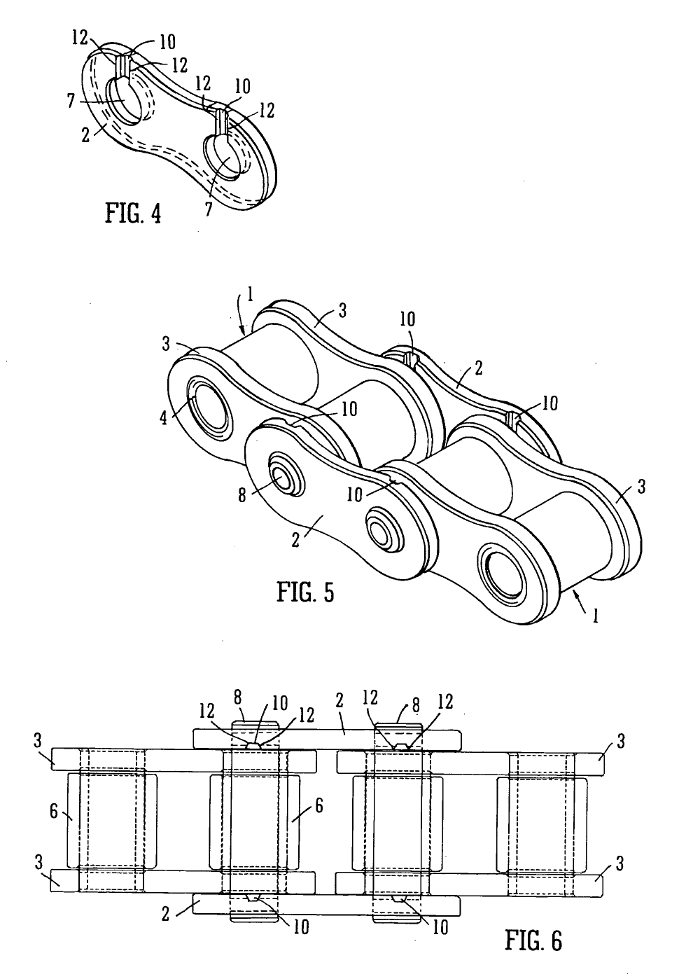

FIG. 4 is a perspective view of an outer link of a second embodiment of a roller bush chain in accordance with the present invention;

FIG. 5 is a perspective view of part of the second embodiment of a roller bush chain fitted with outer links of FIG. 4 and in accordance with the present invention;

FIG. 6 is a plan view of the chain of FIG. 5;

FIG. 7 is a perspective view of a bush in accordance with a third embodiment of a roller bush chain of the present invention;

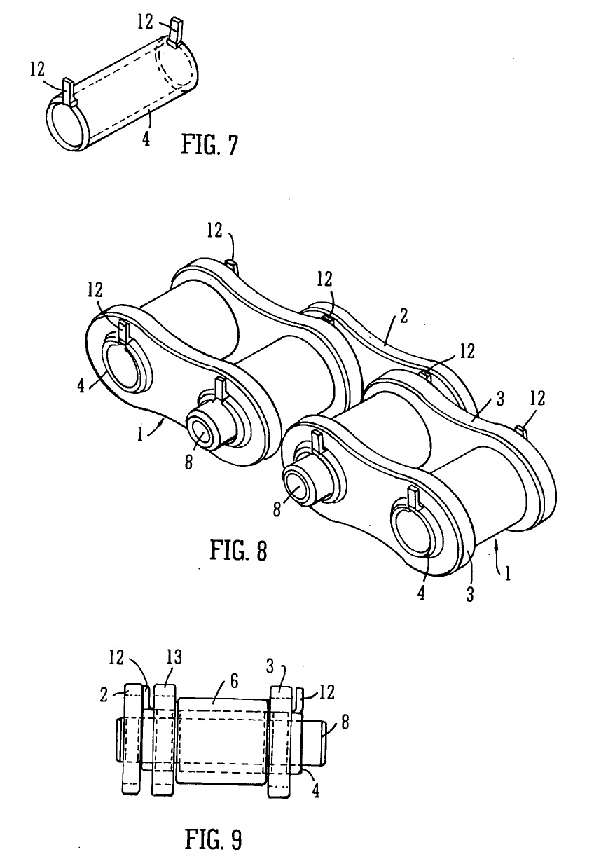

FIG. 8 is a perspective view of the third embodiment of part of the roller bush chain of the present invention fitted with the bush of FIG. 7 with an outer link removed for clarity;

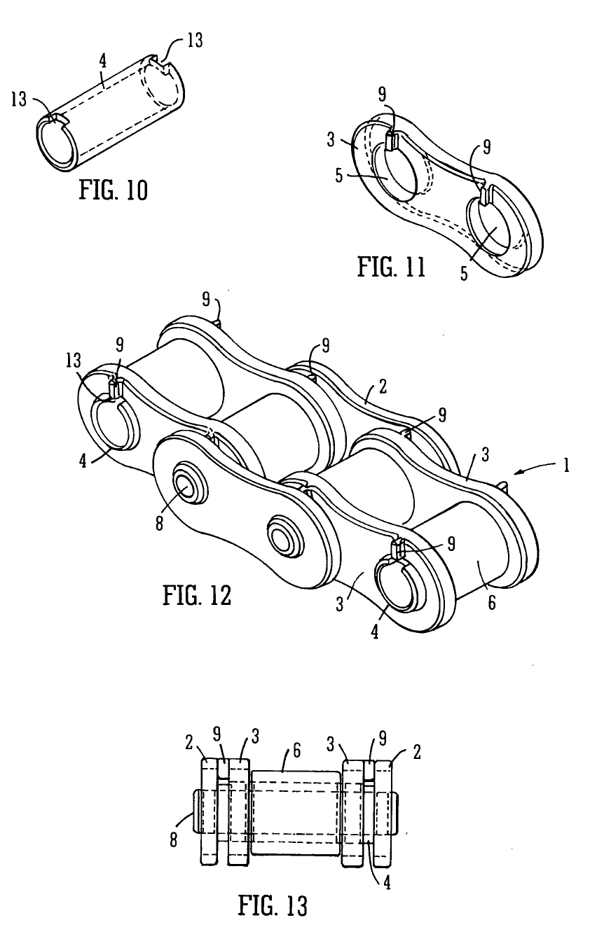

FIG. 9 is an end view of the chain of FIG. 8;

FIG. 10 is a perspective view of a bush of a fourth embodiment of a roller bush chain of the present invention;

FIG. 11 is a perspective view of an inner link of the fourth embodiment of a roller bush chain of the present invention;

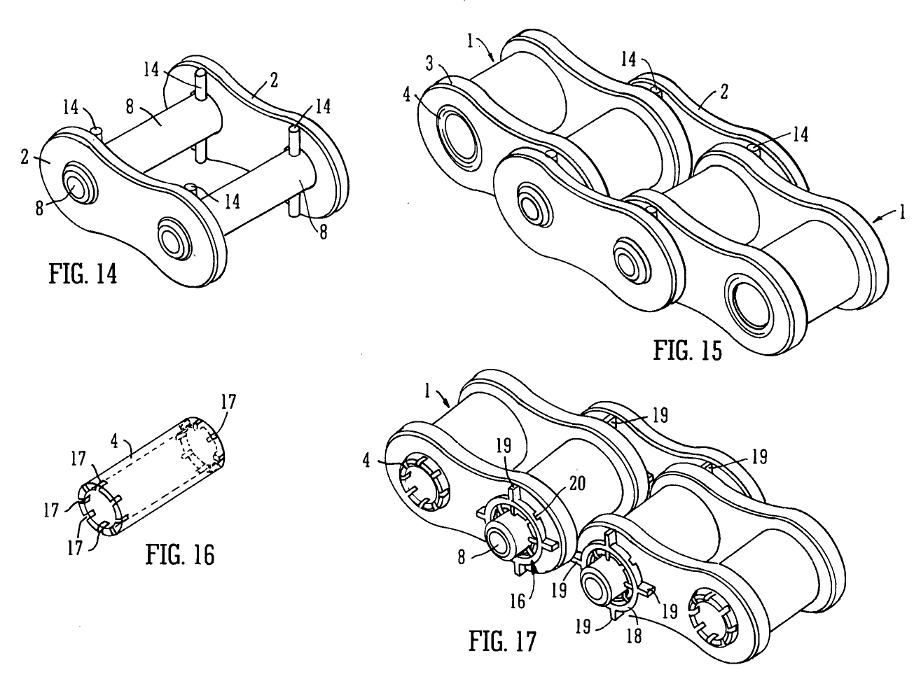

FIG. 12 is a perspective view of part the fourth embodiment of part of the roller bush chain;

FIG. 13 is an end view of the fourth embodiment of the chain of FIG. 12;

FIG. 14 is a perspective view of outer link plates and pins of a fifth embodiment of a roller bush chain in accordance with the present invention;

FIG. 15 is a perspective view of the fifth embodiment of part of the chain of the present invention;

FIG. 16 is a perspective view of a bush of the sixth embodiment of a roller chain in accordance with the present invention, with an outer link plate removed for clarity;

FIG. 17 is a perspective view of part of the sixth embodiment of the chain;

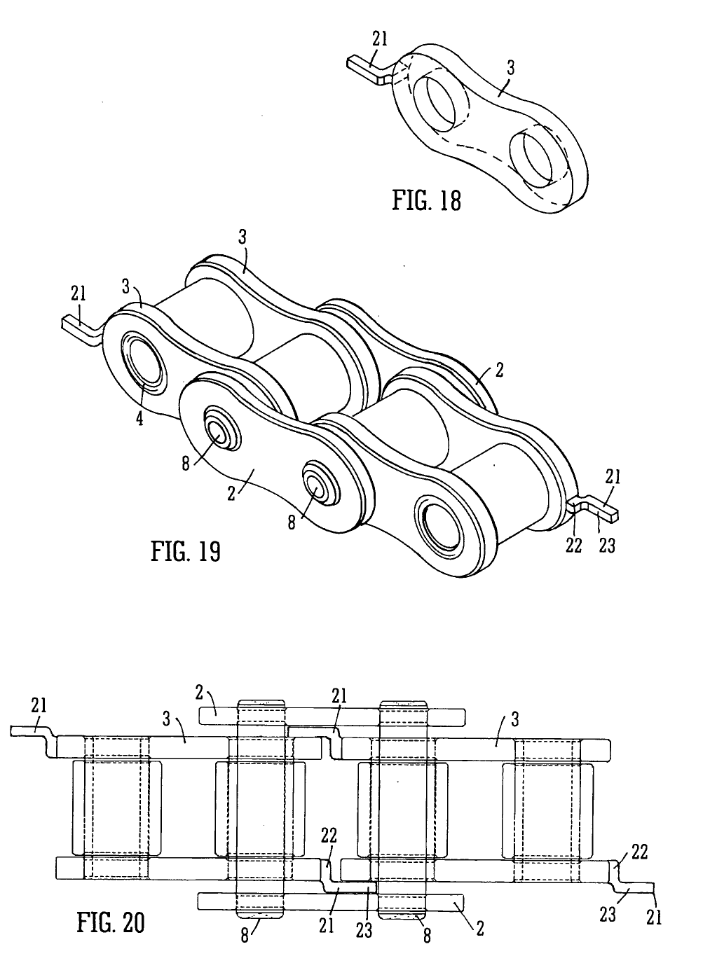

FIG. 18 is a perspective view of an inner link plate of a seventh embodiment of a roller bush chain of the present invention;

FIG. 19 is a perspective view of part of the seventh embodiment of the roller bush chain of FIG. 18;

FIG. 20 is a plan view of the chain of FIG. 19;

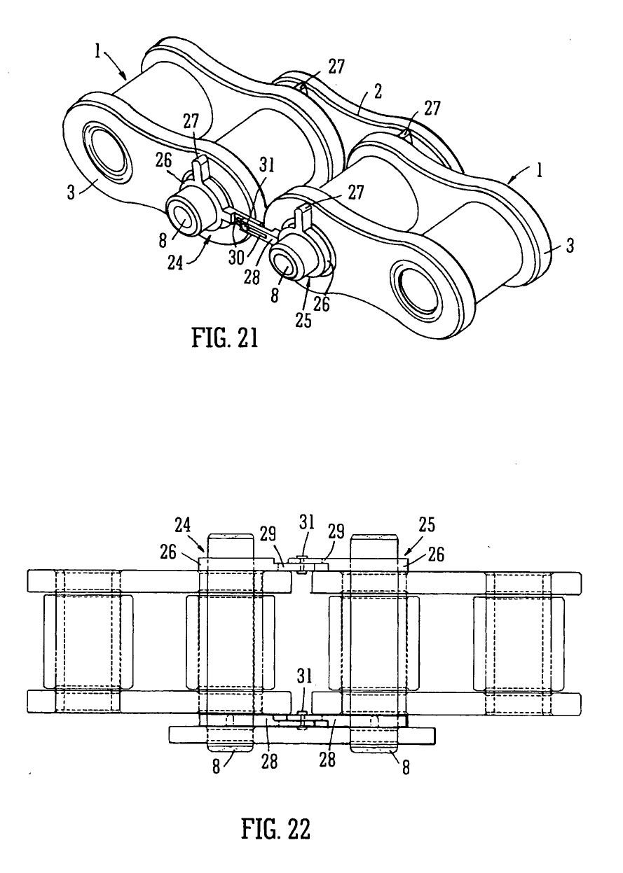

FIG. 21 is a perspective view of part of an eighth embodiment of a roller bush chain in accordance with the present invention, with an outer link plate removed for clarity;

FIG. 22 is a plan view of the chain of FIG. 21;

FIG. 23 is a perspective view of part of a ninth embodiment of a roller bush chain in accordance with the present invention, with an outer link plate removed for clarity;

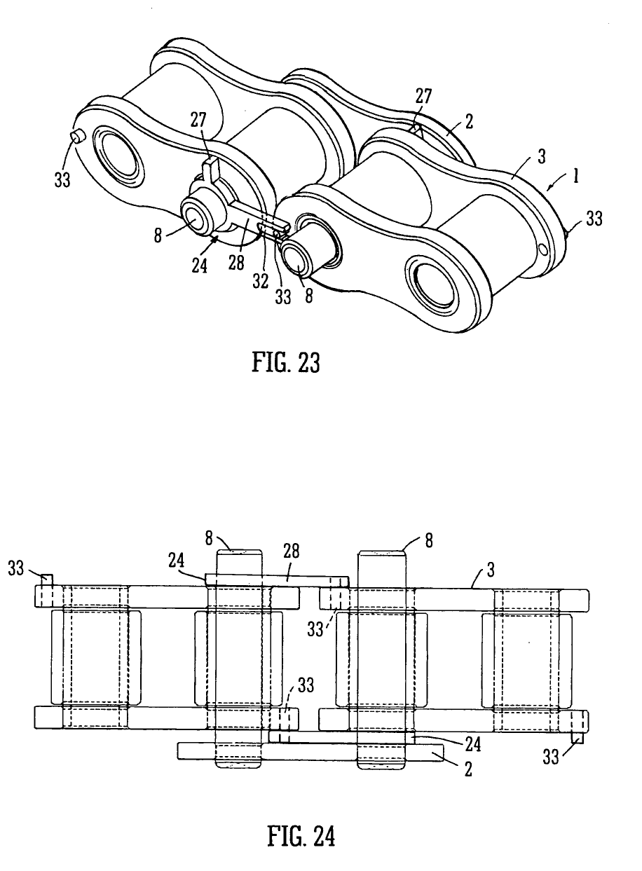

FIG. 24 is a plan view of the chain of FIG. 23;

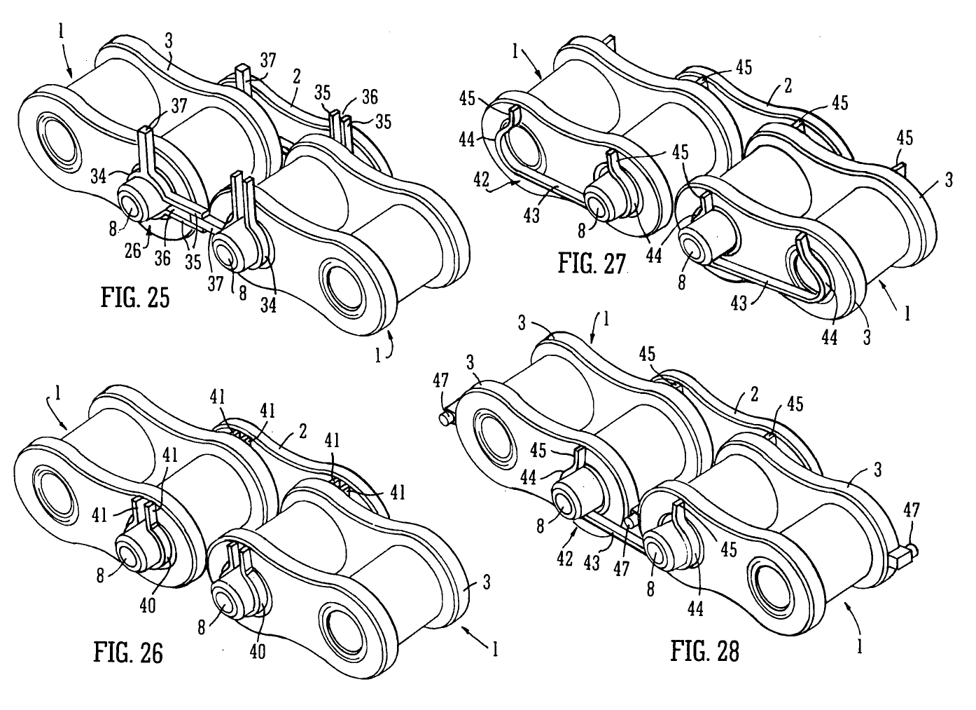

FIG. 25 is a perspective view of part of a tenth embodiment of a roller bush chain in accordance with the present invention, with an outer link plate removed for clarity;

FIG. 26 is a perspective view of part of an eleventh embodiment of a roller bush chain in accordance with the present invention, with an outer link plate removed for clarity;

FIG. 27 is a perspective view of part of a twelfth embodiment of a roller bush chain in accordance with the present invention, with an outer link plate removed for clarity;

FIG. 28 is a perspective view of part of a thirteenth embodiment of a roller bush chain in accordance with the present invention, with an outer link plate removed for clarity;

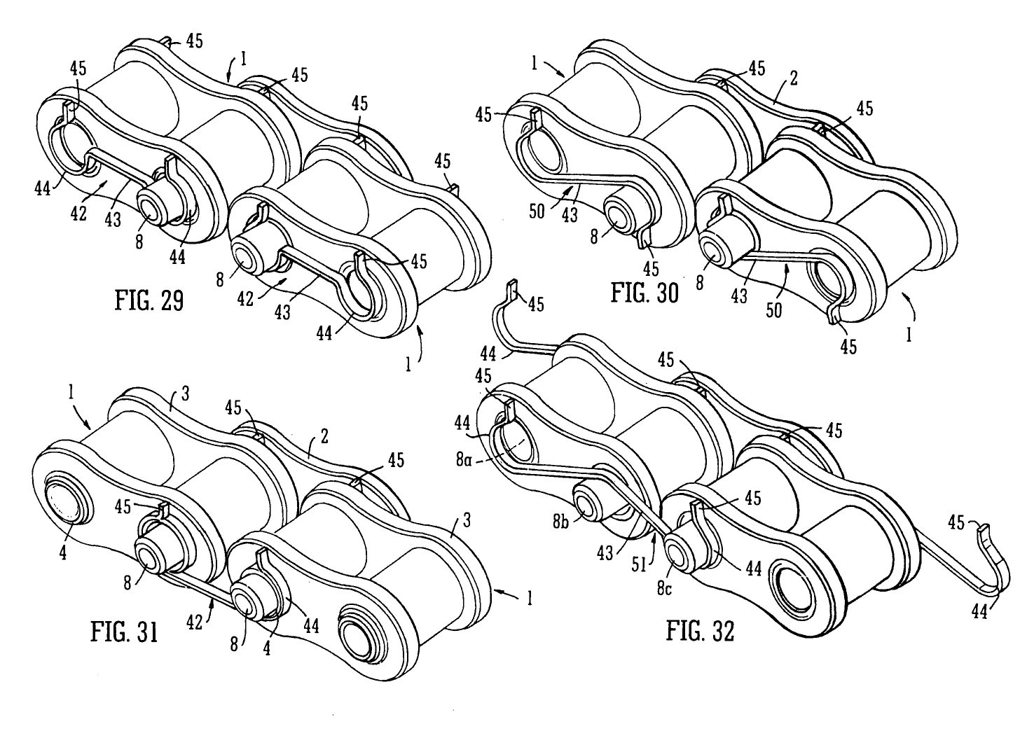

FIG. 29 is a perspective view of part of a fourteenth embodiment of a roller bush chain in accordance with the present invention, with an outer link plate removed for clarity;

FIG. 30 is a perspective view of part of a fifteenth embodiment of a roller bush chain in accordance with the present invention, with an outer link plate removed for clarity;

FIG. 31 is a perspective view of part of a sixteenth embodiment of a roller bush chain in accordance with the present invention, with an outer link plate removed for clarity;

FIG. 32 is a perspective view of part of a seventeenth embodiment of a roller bush chain in accordance with the present invention, with an outer link plate removed for clarity;

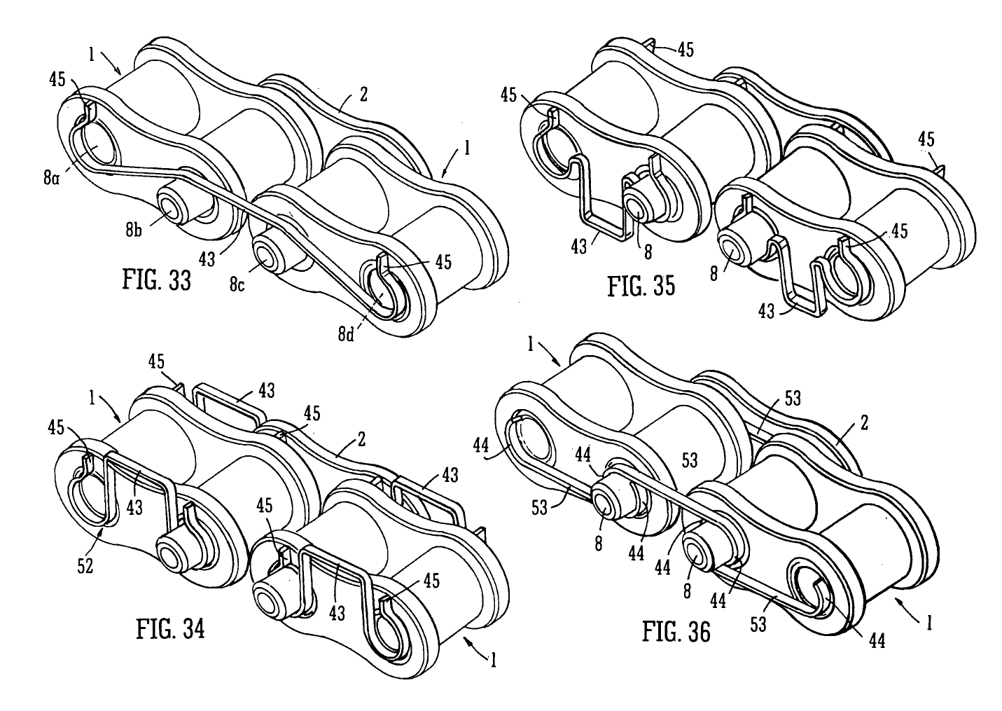

FIG. 33 is a perspective view of part of an eighteenth embodiment of a roller bush chain in accordance with the present invention, with an outer link plate removed for clarity;

FIG. 34 is a perspective view of part of a nineteenth embodiment of a roller bush chain in accordance with the present invention, with an outer link plate removed for clarity;

FIG. 35 is a perspective view of part of a twentieth embodiment of a roller bush chain in accordance with the present invention, with an outer link plate removed for clarity;

FIG. 36 a perspective view of part of a twenty-first embodiment of a roller bush chain in accordance with the present invention, with an outer link plate removed for clarity;

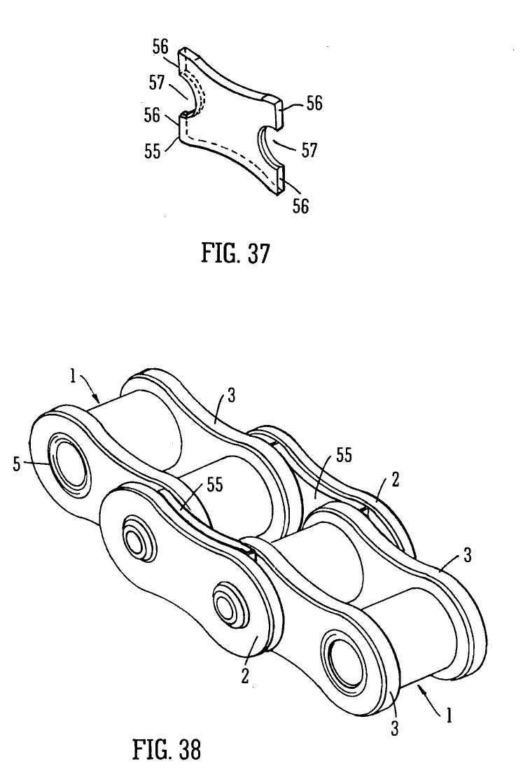

FIG. 37 is a perspective view of a cleaning link for a twenty-second embodiment of a roller bush chain in accordance with the present invention;

FIG. 38 is a perspective view of part of a twenty-second embodiment of a roller bush chain in accordance with the present invention, fitted with the link of FIG. 37;

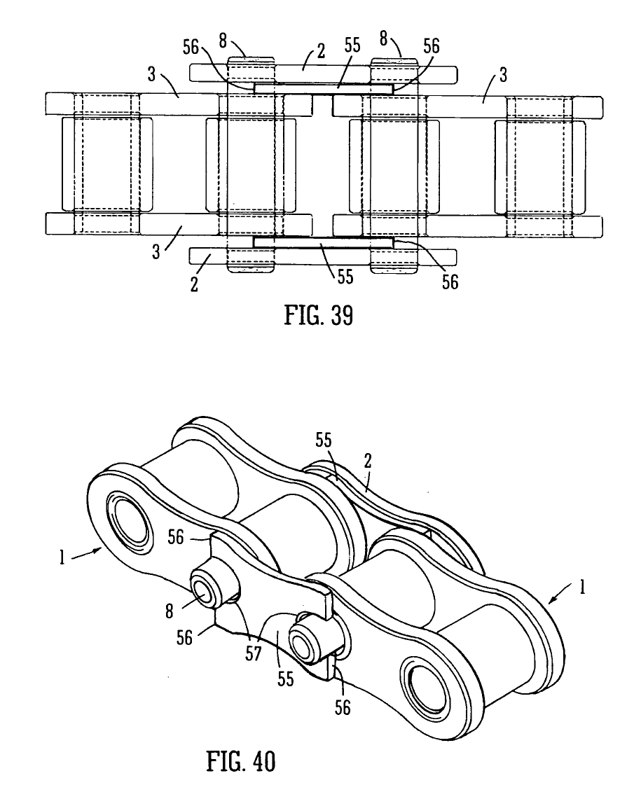

FIG. 39 is a plan view of the chain of FIG. 38;

FIG. 40 is a perspective view of part of a twenty-third embodiment of a roller bush chain in accordance with the present invention, with an outer link plate removed for clarity;

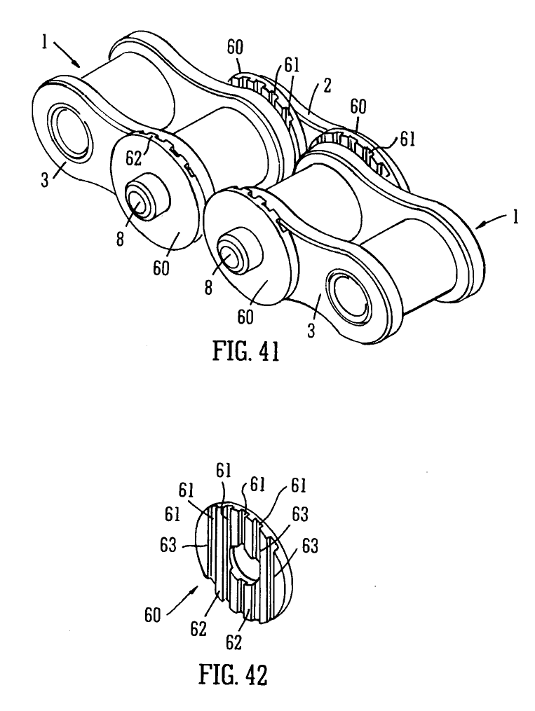

FIG. 41 is a perspective view of part of a twenty-fourth embodiment of a roller bush chain in accordance with the present invention, with an outer link plate removed for clarity;

FIG. 42 is a perspective view of a cleaning washer of the chain of FIG. 41;

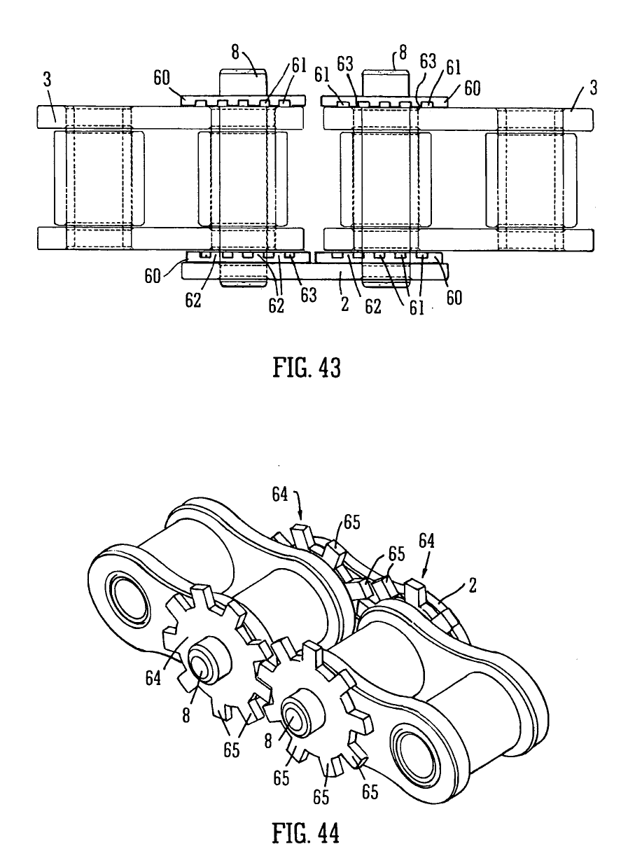

FIG. 43 is a plan view of the chain of FIG. 41; and

FIG. 44 is a perspective view of a twenty-fifth embodiment of a roller bush chain in accordance with the present invention, with an outer link plate removed for clarity.

In all the embodiments shown in the figures the invention is shown as applied to a roller bush chain, although it is to be understood that it may have application to other types of transmission chain with inner and outer link members. In each of the exemplary embodiments the chain has a plurality of inner link assemblies 1 (only two are shown many of the figures, such as, for example, FIGS. 2 and 3) arranged along the length of the chain so as to define a longitudinal chain axis and interconnected by alternate outer link plates 2 in such a manner that they can articulate relative to each other and the outer link plates. In practice such a chain would generally be configured into an endless loop and driven by a toothed sprocket, neither of which are shown in the figures.

Each inner link assembly 1 comprises a pair of opposed spaced inner link plates 3 connected together by a pair of bushes 4 extending perpendicularly to the plates. Each of the inner link plates 3 has a pair of spaced apertures 5 in which the ends of the pair of bushes 4 are received. Each of the opposed inner link plates 3 is mounted in a friction or interference fit on the ends of the bushes 4 in a fixed relationship and a rotatable cylindrical roller 6 is supported on each bush 4 between the inner link plates 3.

The outer link plates 2 are of similar configuration to the inner link plates 3 but with smaller apertures 7 and are arranged to connect together adjacent inner link assemblies 1. A given outer link plate 2 overlaps with adjacent inner link assemblies 1 such that each of its apertures 7 is aligned with a corresponding aperture 5 in the inner link assembly 1 and is connected to the inner link assemblies 1 by pins 8 that pass through the aligned apertures 5, 7 and are received in the bushes 4. The apertures 5 in the inner link assemblies 1 are sized such that the assemblies are free to rotate on the pins 8 but the outer link plates 2 are fixed to the pins 8. More specifically, the apertures 7 in the outer link plates 2 are sized such that the edge of the plate around them is an interference or friction fit with the pins 8.

In the embodiment of FIGS. 1 to 3 the outer link plates 2 each have a pair of ribs 9 that extend inwardly towards the inner link plate 3. The ribs 9 each extend from a respective aperture 7 of the plate to the plate periphery in a generally radial direction with respect to the centre of the aperture. The ribs 9 may be formed integrally with the plate 2 as part of the manufacturing process e.g. by, for example, pressing, machining or material deposition or may be fixedly attached by welding, gluing or any other suitable fixing method. As a further alternative it may comprise a separate component that is releasably connected to the plate 2 by, for example, a clip or the like. In use the ribs 9 serve as a wipers whose elongate edges serve to wipe clean the outwardly facing surface of the inner link plates 3 in the region around the apertures 5 as the link plates 3 articulate relative to one another. This ensures that the region around the apertures 5 of the outwardly facing surface of the inner link plate 3 is substantially clear of any coke deposits, dirt or sludge that otherwise prevents oil getting to the bearing surfaces between each bush 4 and pin 9 and which may cause chain wear.

It will be appreciated that the wiper may take any suitable form and some examples are shown in the following embodiments. It may, for example, be achieved by adding or removing material from or to the inner or outer link plates at the appropriate region. For convenience and ease of understanding the components of the roller bush chains that are common to each embodiment (including that of FIGS. 1 to 3) are labelled with the same reference numbers.

In the embodiment of FIGS. 4 to 6 the wiper is provided by a channel 10 machined into other otherwise formed in the inwardly facing surface of the outer link plate 2. The two elongate edges 12 of the channel 10 extend from the aperture 7 in the outer link plate 2 to its periphery and, in use, serve as wipers to remove the deposits referred to above. Lubricant can be conveniently directed to the pin/bush interface via the channel 10. It is to be understood that any suitably shaped groove may be adopted as the channel and a plurality of channels or grooves may be provided.

In the embodiment of FIGS. 7 to 9, the wiper is provided by an extension 12 at the end of each bush 4. The wiper can be formed integrally with the bush and may be a tab 12 that is bent upwardly to the position shown. Alternatively it may be separately fixed by welding or the like and may or may not be made of the same material as the bush. In operation, the articulation of the chain means that the inner link assemblies 1 including the bush 4 and the wiper 12 articulate relative to the outer link plates 2 so that the inner facing surface of the outer link plate 2 is wiped clean of deposits.

In the embodiment of FIGS. 10 to 13 ribs 9 are formed on the outwardly facing surfaces of the inner link plates 3 above each aperture 5. The bushes 4 are of extended lengths compared to those of a conventional roller bush chain and each end of each bush 4 has a notch 13 cut out at the point immediately below the rib 9, the notch extending from the outside surface to the inside surface of the bush 4. In use, the edges of each rib 9 clean debris etc. from the inwardly facing surface of the outer link plate 2 and lubricant can be applied such that it passes through the notches 13 to the pins 8.

The wiper may be provided by a component separate from the link plates as shown in the embodiment of FIGS. 14 and 15. In this embodiment the wiper is formed from a cylindrical rod 14 that passes through a respective bore 15 in the pin 8 of the chain and extends between the inner and outer link plates 3, 2. The rod 14 may simply be a friction or interference fit or may be fixed by any suitable joining technology including welding or gluing or the like. As the chain articulates the outwardly facing surfaces of the inner link plates 1 are wiped in the region around the apertures 5 by the contacting part of the surface of the rods 14. It will be appreciated that the rod 14 need not be cylindrical in cross-section but could take any suitable form.

In the embodiment of FIGS. 16 and 17 the wiper is provided by a washer 16 that is seated on an extended bush 4 between the inner and outer link plates 3,2. The opposed ends of each bush 4 each have an array of cut-out notches 17 arranged at equi-angular spacings around the bush. Some of the notches are designed to locate the washer and others are designed to direct lubricant to the pin 8. The washer 16 is a separate component formed from any suitable material and comprises an annulus 18 with four wiper blades 19 extending in a generally radial direction and spaced at equal angular intervals. The blades 19 extend radially inwardly and outwardly of the annulus 18, the radially inward extending portions being received in four of the notches 17 defined in the end of the bush 4. The inwardly facing surface of the washer 16 is itself provided with four notches 20, one provided between each blade 19 and each penetrating through the annulus 18. In operation the notches 20 in the annulus serve to allow lubricant to pass to the bush 4 and the blades 19 serve to wipe the inwardly facing surface of the outer link plates 2.

In a further alternative embodiment illustrated in FIGS. 18 to 20, the wiper is provided by an elongate finger 21 projecting from one end each inner link plate 3. The finger is stepped, that is to say it has a first portion 22 fixed to the end edge of the link plate 3 that extends outwardly of the chain in a direction substantially perpendicular to the longitudinal axis of the chain and a second terminal portion 23 that extends in a direction substantially parallel to the axis. When the chain is assembled the shape of the finger 21 is such that it extends over the adjacent end of the neighbouring inner link plate 3 and between the outwardly facing surface of that link plate 3 and the inwardly facing surface of the overlying outer link plate 2, as best seen in FIG. 20. In use the finger 21 serves to wipe the inwardly facing surface of the outer link plate 2 in the region around the pin apertures 7 but may also be arranged so as to wipe the outwardly facing surface of the neighbouring inner link plate 3. The finger 21 may be an integral part of the link plate 3 and formed as part of the blanking process or may be a separate element that is fixed to the plate by means of any appropriate means such as, for example, welding or gluing.

A wiper arrangement for wiping both the outwardly facing surface of the inner link plate 3 and the inwardly facing surface of the outer link plate 2 is shown in FIGS. 21 and 22, In this embodiment a wiper arrangement is supported on the neighbouring pins 8 of adjacent inner link assemblies 1 and comprises first and second wiper members 24, 25 each comprising an annular collar 26 with a substantially radially extending wiper blade 27 and a substantially radially extending link arm 28 disposed at substantially 90 degrees to the wiper blade. The link arms 28 are each inwardly stepped adjacent to the collar 26 so as to define a terminal portion 29 of reduced thickness, that portion 29 having a slot 30 along its length. The wiper members 24, 25 are each disposed such that the collars 26 are rotatably mounted on the pins 8 of the adjacent link assemblies 3 with one member 24 in a reverse orientation compared to the other 25 such that the reduced thickness terminal portions 29 of the link arms 28 are in an overlapping relationship. A link pin 31 is slidably received in the overlapping slots 30 in the link arms 28 so as to connect them together. In use, the wiper members 24, 25 rotate on the pins 8 and work against one another during articulation of the chain. The wiper blades 27 (and potentially the link arms 28) serve to wipe deposits from the surfaces of the link plates 2, 3. In a variant to this embodiment one of the wiper members 24, 25 may be fixed relative to the inner link assemblies 1 so that it is driven in rotation as the assembly articulates on the pins 8.

Further variations on the arrangement described immediately above are shown in FIGS. 23 to 25. In the embodiment of FIGS. 23 and 24 a single wiper member 24 is supported on only one of the pins 8. The link arm 28 has an open slot 32 which receives a link pin 33 fixed on the outwardly facing surface of the adjacent inner link plate 3. As the inner link assemblies 1 pivot relative to one another the link pin 33 acts as a cam driving the wiper member 24 in rotation so that the wiper blade 27 wipes the facing surfaces of the inner and outer link plates 3, 2.

In FIG. 25, the collar 26 of each wiper member is not fully annular and instead is in the form of a resilient clip 34 with a partially annular portion that is mounted on a respective chain pin and from which extends two parallel arms 35 that define an open slot 36 between them. As before, an elongate wiper blade 37 extends from the collar 26 in a substantially radial direction. The wiper members are disposed such that they are interconnected with the wiper blade 37 of one being received in the slot 36 between the arms 35 of the other. As the chain articulates the wiper members are free to pivot on the pins 8 and the interconnection ensures they work against one another so that the free wiper blade 37 (on a first of the wiper members) and the free arms 36 (on the other of the wiper members) serve to wipe clean the facing surfaces of the inner and outer link plates 3, 2. As in the embodiment of FIGS. 22 and 23, at least one of the wiper members may be fixed to the chain pin 8 or the inner link plate 3.

In the embodiment of FIG. 26 the wiper member is a single clip 40 with a pair of arms 41 serving as the wiper blades. The clip is rotatably supported on each of the pins 8 and serves to wipe clean the facing surfaces of the inner and outer link members.

FIGS. 27 to 36 shown different embodiments of the same general idea of providing one or more clips on the pins 8 between the inner and outer link plates 3,2 of the chain, the clip defining at least one wiper blade for cleaning at least one of the facing surfaces of the inner and outer link plates in the region around the pin 8. In each case the clips are manufactured from any suitable resilient material that is capable of withstanding the high temperatures in pin ovens such as, for example, spring steel. However, they may have application to chains in other environments in which case the material may not need to withstand such high temperatures.

In FIG. 27 the clip 42 is a unitary member that is clipped over adjacent pins 8 and against an inner link plate 3. It comprises an elongate portion 43 that extends in a direction substantially parallel to the longitudinal axis of the pins 8 and is intermediate arcuate end portions 44 that pass around each pin and terminate in a wiper blade 45 that extends substantially radially with respect to the pin 8. The resilient nature of the clip material means that the end portions 44 can flex relative to the elongate portion 43 so as to facilitate mounting of the clip 42 to the pins 8. In operation, as the chain is driven in a loop around a chain drive it is typically under tension on one side of the loop and is slack on the other side. When under tension the pins of the chain are pulled apart which causes flexing of the end portions 44 and therefore the wiper blades 45.

The clip 42 of FIG. 28 is identical to that of FIG. 27 but is mounted so as to extend between the pins 8 of a common outer link plate 2 (and therefore pins of neighbouring inner link assemblies 1). A protrusion 47 extends laterally of the chain at one end of each inner link plate 3 and, in operation, comes into contact with the elongate portion 43 of the clip 43 during articulation of the link assemblies 1. This puts the elongate portion 43 of the clip 42 under tension and the arcuate end portions 44 ride over the pins 8 so as to cause the wiper blades 45 to flex.

In FIG. 29, the elongate portion 43 of the clip 42 is positioned so as to be level with the centres of the pins 9 resulting in the arcuate end portions 44 being more pronounced. The mounting of the clip and operation of the wiper is the same as that of FIG. 27.

In FIG. 30 the clip 42 is the same as that of FIGS. 27 and 28 but is mounted on the ends of extended bushes 4 of adjacent inner link assemblies 1, rather than on the pins 8. The ends of the bushes 4 project from the inner link plates 3 on each side and support the arcuate end portions 44 of the clip.

FIG. 31 shows a further variation on the embodiment of FIGS. 27 and 29 with the clip 50 in this instance taking the form of an S-shape with the elongate portion 43 extending diagonally from a position towards the bottom of one pin 8 to a position towards the top of the adjacent pin 8. This provides for wiper blades 45 that extend in opposite directions.

The clip 51 of FIG. 32 is longer than those described in the preceding embodiments in that it extends to cover the span of three pins 8a, 8b, 8c. Pin 8a is not shown in the figure but the reference number is used to indicate its position. The arcuate end portions 44 are supported on two pins 8a, 8c at each end of the clip 51 as before but the elongate portion 43 is deflected upwardly by contact with the intermediate pin 8b. As the chain articulates the intermediate pin 8b changes the tension in the elongate portion 43 and effectively causes the wiper blades 45 to flex. A similar arrangement is shown in FIG. 33 in which the clip is even longer so as to span four pins 8a-8d (pins 8a and 8d not shown but their positions are labelled) and two inner link assemblies 1. There are two intemiediate pins 8b, 8c, one on each inner link assembly 1. In this embodiment only one end of each inner link assembly 2 is wiped by the wiper blades 45.

In the embodiment of FIG. 34, the clip 52 is similar to that of FIG. 29 except that the intermediate elongate portion 43 is configured in a inverted substantial U-shape such that part of it is disposed above the peripheral edge of the link plates 2, 3. In operation the elongate portion 43 comes into contact with a ramped surface (not shown) provided alongside the chain or a similar surface provided on the drive sprocket, so as to effect flexing of the wiper blades 45. FIG. 35 shows a variation to this clip in which the U-shape is not inverted. In this arrangement any force applied to the clip when it comes into contact with the ramped surface does not risk removing the clip from the pins 8.

The clips 53 shown in the embodiment of FIG. 36 each have shorter arcuate end portions 44. The clips are arranged to extend between adjacent pins 8 along the length of the chain, alternate clips 53 being inverted. The shorter end portions 44 and the inversion of alternate clips 53 allows each pin 8 to support opposite ends 44 of two clips in the manner shown. When the chain in under tension the clips 53 are loaded under tension and the end portions flex so as to wipe the areas of the link plates around the pins 8.

FIGS. 37 to 39 show an alternative wiper concept in which a modified plate 55 is disposed between the inner and outer link plates 3, 2 to serve as a cleaning plate. The modified plate 55 is essentially the same configuration as an outer link plate 2 but with its ends removed along a line that intersects the centre of the apertures 7 to leave substantially vertical edges 56 that serve, in use, as the wiper blades. At each of the modified plate 55 the vertical end edges 56 are interrupted by a substantially semi-circular recess 57 by which the plate is supported on the pins 8. These recesses 57 are effectively what remains of the pin apertures of the unmodified link plate. The modified link plate 55 underlies an outer link plate 2 and thus extends between adjacent inner link assemblies 1. In operation the vertical edges 56 serve to wipe clear the outwardly facing surfaces of the inner link plates 3 in the region around the apertures 5.

A modified version of the preceding embodiment is shown in FIG. 40 in which the recesses 57 are deeper in that they extend further into the plate 55. This allows affords a clearance between the edge of each recess 57 and the respective pin 8 so as to allow a limited degree of movement of the modified plate 55 relative to the pins 8 in a direction substantially parallel to the longitudinal axis of the chain. This axial movement increases the extent of the wiping action.

In other embodiments of the modified link plate (not shown) the plate may be formed from a generally rectangular blank so that the upper and lower edges are straight rather than waisted. The vertical depth of the plate may be such the upper and lower edges are positioned above or below the corresponding edges of the inner or outer link plates. The wiper edges of the modified link plate may be inclined to the vertical. The modified link plates may be disposed such that they extend over the inner link plate rather than the outer link plate.

FIGS. 41 to 43 illustrate an alternative wiping arrangement in which the pins 8 each support a cleaning washer 60 between the inner and outer link plates 3, 2. The inwardly facing surface of the washer 60 has a plurality of parallel grooves 61 so as to define intervening wiping blades 62 whose edges 63 serve, in use, to wipe the outwardly facing surface of the inner link plates 3. The washers 60 may be rotatably mounted on the pins 8 and designed to engage cam surfaces (not shown) adjacent to the chain path so that they are driven into rotation at regular intervals. The cam surface could be provided on a drive sprocket around which the chain passes. The cam surface may be ramped. The grooves of the washer can be of any suitable form including radial, spiral or other shaped groove. It is to be appreciated that similar grooves may be provided on the outwardly facing surface of the washer. Alternatively, the washer itself may be corrugated. The grooves also provide the benefit of directing lubricant to the bearing interface between the pin and bush.

An alternative washer configuration is shown in FIG. 44 in which the periphery of each washer 64 has a plurality of teeth 65 for inter-engagement with identical teeth provided on the adjacent washer. The wiper blade or edge may be provided by the edges of the teeth themselves or by surface formations on the surface(s) of the washer as in the embodiment of FIGS. 40 to 43. The washer may again be driven by a suitable cam surface provide alongside the path of the chain.

The skilled person will appreciate that a chain according to the present invention could be fitted with one or more of any of the above cleaning arrangements in any appropriate combination.

Although the chains described in the exemplary embodiments herein are all roller bush chains it will be understood that the invention may be applied to other types of transmission chains that do not necessarily have rollers or bushes.

Whilst the particular problems relating to lubrication have been described in relation to a pin over chain. The same problems and disadvantages can apply to other chain applications and therefore the solution presented in this application is not limited to the particular chain type.

While the invention has been illustrated and described in detail in the drawings and foregoing description, the same is to be considered as illustrative and not restrictive in character, it being understood that only the preferred embodiments have been shown and described and that all changes and modifications that come within the scope of the inventions as defined in the claims are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1-32. (canceled)

33. A chain having a longitudinal axis and comprising a plurality of interconnected chain link members, the link members being arranged along the longitudinal axis of the chain into inner link members that are flanked on each side by outer link members, the outer link members extending between adjacent inner link members, a pair of apertures defined in each of the link members and spaced apart in the direction of the axis, the inner link members having an outwardly facing surface with respect to the axis and the outer link members having an inwardly facing surface, the inner and outer link members being arranged such that one of the pair apertures in each of the outer and inner link members are in alignment and such that the outwardly facing surface of the inner link member and the inwardly facing surface of the outer link member partially overlap at an interface region in an area around the aligned apertures, the inner and outer link members being interconnected by the transverse pins that are received in the aligned apertures, at least one wiper element provided at the interface region and defining a wiping edge that contacts, and is movable relative to, at least one of the surfaces in the interface region.

34. A chain according to claim 33, wherein the wiper element is defined by part of an inner or outer link member.

35. A chain according to claim 34, wherein the wiper element is defined by a protrusion on one of the inner or outer link members.

36. A chain according to claim 34, wherein the wiper element is defined by a groove defined in one of the surfaces at the interface region, an edge of the groove providing the wiping edge.

37. A chain according to claim 35, where the protrusion or groove extends in the interface region from one of the apertures in the inner or outer link member to a peripheral edge of that link member.

38. A chain according to claim 33, wherein the inner link member further comprises a bush in which the pins are rotatably received, the wiper being defined by a protrusion extending outwardly from an end of the bush and along the interface region.

39. A chain according to claim 35, wherein the protrusion extends from an edge of a first inner link member into an interface region between an adjacent inner link member and an outer link member.

40. A chain according to claim 39, wherein the protrusion is stepped to define a first portion that extends outwardly of the longitudinal axis of the chain and a second portion that extends in a direction substantially parallel to the axis of the chain, such that it extends around and over the adjacent inner link member.

41. A chain according to claim 33, wherein the wiper element is defined by a separate wiper member disposed between inner and outer link members.

42. A chain according to claim 41, wherein the wiper member is mounted on at least one of the pins.

43. A chain according to claim 41, wherein the wiper member is supported in a bore defined in the at least one of the pins.

44. A chain according to claim 43, wherein the wiper member is elongate and extends outwardly of the pin in a direction transverse to the pin.

45. A chain according to claim 42, wherein the wiper member is movable relative to the at least one of the pins.

46. A chain according to claim 42, wherein the wiper member comprises a first portion supported around the at least one of the pins and a second portion extending outwardly from the first portion, the second portion defining the wiper edge.

47. A chain according to claim 46, wherein the first portion comprises an at least partially annular member.

48. A chain according to claim 46, wherein the second portion comprises at least one arm that extends outwardly of the first portion and defines the wiping edge.

49. A chain according to claim 48, the inner link member comprising at least one bush for receiving a respective pin and the at least one arm of the second portion extends inwardly of the first portion and is received in an opening defined in a bush.

50. A chain according to claim 46, wherein the first portion has a link arm for connection to a corresponding link arm of an adjacent wiper member.

51. A chain according to claim 50, wherein there is provided a first wiper member the first portion of which is supported around a first pin of the chain and a second wiper member the first portion of which is supported around a second pin of the chain, the first and second pins being adjacent to each other in the pins along the chain, the link arms of the first and second wiper members being connected to one another.

52. A chain according to claim 51, wherein the link arms overlap and have slots, a connecting member moveable disposed in the slots so as to connect the link arms together.

53. A chain according to claim 51, wherein a link arm of the first wiper member is received in an open slot of a link arm of the second wiper member.

54. A chain according to claim 48, wherein the first portion is mounted on a first inner link member and comprises a link arm having a slot, the slot slidably receiving a protrusion on a second inner link member, the first and second inner link members being adjacent to one another.

55. A chain according to claim 41, wherein the wiper member is in the form of a resilient clip.

56. A chain according to claim 55, wherein the resilient clip defines a first portion by which it is supported on the pin and at least one arm extending outwardly with respect to the pin and defining the wiping edge.

57. A chain according to claim 55, wherein the clip defines a pair of end portions at least one of which defines the wiper element.

58. A chain according to claim 57, wherein the clip comprises an intermediate portion between said end portions, the end portions being arranged around the pin or pins of the chain.

59. A chain according to claim 58, wherein the intermediate portion extends between two or more pins of the chain.

60. A chain according to claim 59, wherein the intermediate portion is arranged so as to be engageable by a protrusion defined on an inner link member during articulation of the chain, the engagement effecting flexing or movement of the wiping edge defined on the end or ends of the wiper member.

61. A chain according to claim 59, wherein the intermediate portion extends outboard of the peripheral edge of the inner link member and is engageable by a cam surface arranged alongside the path of the chain.

62. A chain according to claim 42, wherein the wiper member is a plate having at least one edge that defines the wiping edge, the plate being disposed between the inner and outer link members.

63. A chain according to claim 42, wherein the wiper member has a surface that faces the inner link member, the surface having at least one groove whose edge defines the wiping edge.

64. A chain according to claim 63, wherein the wiper member is in the form of a washer rotatably supported on a pin.
